(19) United States
(12) Patent Application Publication
(10) Pub. No.: US 2021/0209847 A1
(43) Pub. Date: Jul. 8, 2021

(54) METHOD FOR GENERATING A 3D DIGITAL MODEL, PHYSICAL MOLD USED FOR CREATING A HAIRPIECE AND METHOD FOR GENERATING THE SAME

(71) Applicant: TRUE HAIR LLC, Somerville, MA (US)

(72) Inventors: Shing-Tung YAU, Somerville, MA (US); Eugene M. YAU, Somerville, MA (US); Dale Owen ROYER, Somerville, MA (US)

(21) Appl. No.: 16/639,525

(22) PCT Filed: Aug. 13, 2018
(86) PCT No.: PCT/US18/46437

§ 371 Date: Feb. 14, 2020

Related U.S. Application Data
(60) Provisional application No. 62/545,775, filed on Aug. 15, 2017.

(51) Int. Cl. G06T 17/20; G06T 19/20; B29C 64/393; B33Y 50/02

(52) U.S. Cl. CPC G06T 17/20; G06T 19/20; G06T 2219/2012; B33Y 50/02; G06T 2219/2004; B29C 64/393

(57) ABSTRACT

A method of 3D modeling for hairpiece manufacturing, comprising: scanning a head and obtaining an initial 3D model of the head with 3D geometry and color information; displaying the 3D model to user on a display; receiving user input about an indication; and forming a corresponding indication on the 3D model, so as to obtain a refined 3D model. A physical mold used for creating a hairpiece and a method for generating the same are also disclosed according to other aspects of the present disclosure.

This disclosure relates to custom manufacturing of hairpieces. More specifically, this disclosure relates to a method for generating a 3D digital model with an indication used for creating a hairpiece, a physical mold used for creating a hairpiece, and a method for generating a physical mold.

### BACKGROUND

Many individuals lose naturally growing hair due to, for example, diseases or aging, or just by heredity. Hairpieces provide an important way for improving/changing one's appearance. Previously, an area on one's head, large or small, in which hair is lost, was first outlined and measured, and a hairpiece formed on a flat base material was tailored to the size of this area and then attached to the head to cover the area, by means of, for example, gluing, using double sided tape, clips, or braiding. One problem with this approach is that, the base material of the hairpiece is flat in shape and when it is attached to the head, creases occur and cause the hairpiece not to fit the curved shape of a head shell very well. It may look bad or cause a loose/unstable attachment of the hairpiece to a head.

In consideration of the above, custom made hairpieces have been proposed. For manufacturing a custom made hairpiece, a 3D model is scanned on the spot and sent to a mold manufacturer, and a physical mold of a head shell is usually produced in accordance to 3D model of the customer's head at a mold manufacturer, and then shipped to a hairpiece manufacturer, where a hairpiece is custom made by using the physical mold and can be made to fit the mold and thus fit the customer's head very well.

Besides head profile presented by the physical mold, for creating a hairpiece, it is also required to provide information regarding to, for example, orientation of the mold with respect to the corresponding head, an area to be covered with the hairpiece, and requirements about hair color, hair length and so on. Usually the physical mold and the information required for creating a hairpiece are provided to a hairpiece manufacturer separately, which may cause inconvenience and/or error in making use of the information.

### SUMMARY

A need exists for an improved approach for providing the information required for creating a hairpiece.

Accordingly, in an aspect of the present disclosure, a method for generating a 3D digital model with an indication used for creating a hairpiece is provided, which comprises: obtaining an initial 3D model of a head; obtaining information required for creating the hairpiece; and generating an indication on a surface of the 3D model, which represents the information and forms as a part of the 3D model.

In another aspect of the present disclosure, a method for generating a physical mold used for creating a hairpiece is also provided, which comprises: obtaining an initial 3D digital model of a head; obtaining information required for creating the hairpiece; generating an indication on a surface of the 3D model, which represents the information and forms as a part of the 3D model; and generating a physical mold based on the 3D model.

In a further aspect of the present disclosure, a physical mold used for creating a hairpiece, comprising a body having a work surface that is corresponding to a surface of a head, wherein the work surface of the body is formed with an indication, which represents information required for creating the hairpiece.

In yet another aspect of the present disclosure, one or more processor readable storage devices are provided, which have encoded thereon instructions for causing one or more processors to perform the method for generating a 3D digital model with an indication used for creating a hairpiece as described above.

In yet another aspect of the present disclosure, a system for generating a 3D digital model with an indication used for creating a hairpiece is provided, which comprises: one or more processors and one or more processor readable storage devices, wherein the one or more processor readable storage devices have encoded thereon instructions for causing the one or more processors to perform the method for generating a 3D digital model with an indication used for creating a hairpiece as described above.

### BRIEF DESCRIPTION OF THE DRAWINGS

Other features, objects, and advantages of the present disclosure will become more apparent from the following detailed description when taken in conjunction with the accompanying drawings, in which:

FIG. 1 is a flow chart illustrating a method for creating a custom made hairpiece of the present disclosure;

FIG. 2 is a flow chart illustrating a method for generating a 3D digital model with an indication used for creating a hairpiece of the present disclosure;

FIG. 3 and FIG. 4 show an example of a 3D model with orientation indicator thereon, wherein FIG. 3 shows a front side of the model and FIG. 4 shows a back side of the model;

FIG. 5 schematically illustrates a process for extruding a circle along a curve;

FIG. 6 shows an example of a solid 3D geometry generated along an outline of a target area with the process of FIG. 5;

FIG. 7 shows an example of a target area indicator which is in the form of raised structure on the surface of the 3D model;

FIG. 8 shows another example of a target area indicator, which is in the form of indentation in the surface of the 3D model;

FIG. 9 shows an example of a 3D model with target area indicator and part line indicator in the form of color feature;

FIG. 10 shows another example of a 3D model with target area indicator and part line indicator in the form of structural feature;

FIG. 11A shows an example of a 3D model with hairpiece indicator and section indicator;

FIG. 11B schematically shows exemplary hair sections; and

FIG. 12 shows an example of a physical mold used for creating a hairpiece of the present disclosure.

### DETAILED DESCRIPTION

The present application will now be described in further detail with reference to the accompanying drawings and examples. It is to be understood that the specific embodiments described herein are for the purpose of explaining the related invention and are not intended to limit the invention. It should also be noted that, for the sake of convenience of description, only parts related to the invention are shown in the accompanying drawings. To be specified, the embodiments in the present application and the features in the embodiments can be combined with each other without conflict.

The expression “exemplary”, “example” or various forms thereof are used herein to mean serving as an example, instance or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of a varying scope could have been presented, but have been omitted for purposes of brevity.

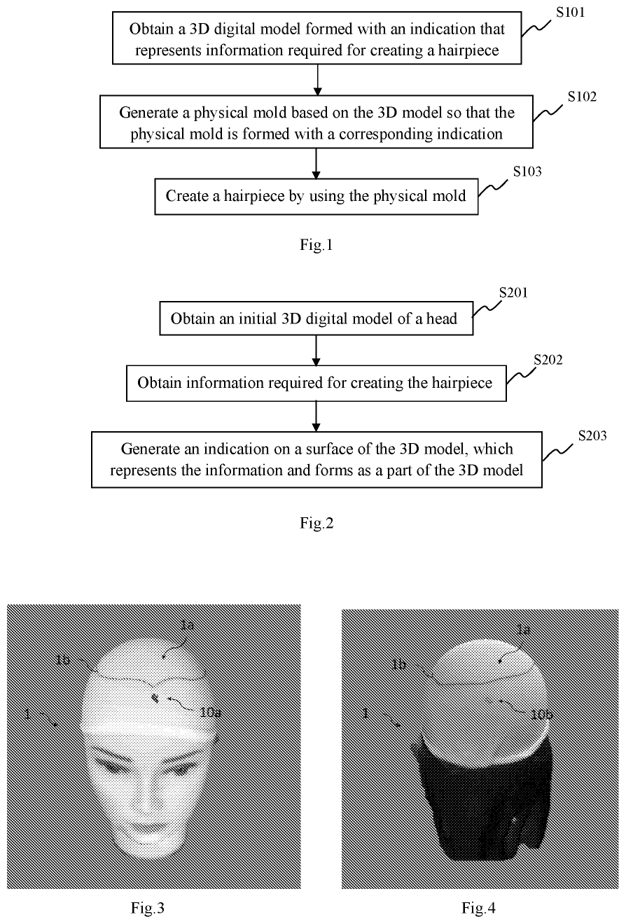

In one aspect, the present disclosure provides a method for creating a custom made hairpiece. FIG. 1 is a flow chart illustrating the method.

As shown in FIG. 1, first, in step S101, a 3D digital model is obtained, which is formed with an indication that represents information required for creating a hairpiece. This can be fulfilled with the method for generating a 3D digital model with an indication used for creating a hairpiece of the present disclosure, which will be described in more details later.

Here, information required for creating a hairpiece includes, but not limited to: orientation information specifying orientation of a 3D model/mold with respect to a head; position information specifying position of a target area to be covered by a hairpiece (e.g., a hair loss area) on the 3D model/mold; hairpiece information specifying requirement for the hairpiece, such as hair color, hair length; and section information specifying hair sections.

The indication can be a structural feature (e.g., a raised structure or an indentation), a color feature, or combination of a structural feature and a color feature. This will be explained more specifically later.

In step S102, a physical mold is generated based on the 3D digital model obtained through step S101, and accordingly the physical mold is formed with a corresponding indication which represents information required for creating the hairpiece.

In some embodiments, a physical mold can be generated based on a 3D digital model by using 3D printer or a computerized carving machine. The mold can be either printed, for example in plastic, using a 3D printer, or carved out of, for example dense foam, using a subtractive carving process.

Indication can be physically created in the physical mold based on the 3D digital model. In some embodiments where indication is a structural feature, such as a raised structure or an indentation, the indication can be 3D printed or carved out of material. In some other embodiments where indication is a color feature, the color feature can be applied to the physical mold through material choices during the manufacturing process of creating the mold or application of a paint, dye or other coloring method that is applied to the surface of the mold.

With step S102, the virtual information in a computer is transferred into the physical mold through for example carving of dense foam, or 3D printed in plastic or other material. The resulting mold is a physically accurate representation of the 3D data in the computer.

Then, in step S103, a hairpiece is created by using the physical mold and by referring to the information represented by the indication on the physical mold. The physical mold can be used to directly place a base material on the mold and tie the “hair” to the base material so as to create a hairpiece.

Once information required for creating a hairpiece is represented on a physical mold so as be provided to hairpiece manufacturer, it will be much more convenient and reliable in making reference to the information. Furthermore, for at least some of the information, such as position information specifying position of a target area on the mold, can be represented in a more accurate and precise way as compared to the situation in which the information is separated from the mold and provided to a hairpiece manufacturer.

In another aspect, the present disclosure provides a method for generating a physical mold used for creating a hairpiece, which comprises the above step S101 and step S102. Reference can be made to the flow chart of FIG. 1 as well as the above discuss for details of these steps, and repeated description is omitted here for the sake of brevity.

With the method for generating a physical mold of the present disclosure, a physical mold formed with indication that represents information required for creating a hairpiece can be generated in a convenient and precise way by directly making use of a 3D digital model, which is formed with such indication already. Thus, with the method of the present disclosure, it is much more convenient and reliable not only for a hairpiece manufacturer to refer to the information required for creating a hairpiece, but also for a mold manufacturer to generate a physical mold formed with indication representing the required information.

In a further aspect, the present disclosure provides a method for generating a 3D digital model with an indication used for creating a hairpiece. This method can be used to fulfill step S101 in the method for creating a hairpiece and the method for generating a physical mold used for creating a hairpiece of the present disclosure.

FIG. 2 is a flow chart of the method for generating a 3D digital model with an indication used for creating a hairpiece according to embodiments of the present disclosure.

In step S201, an initial 3D digital model of a head is obtained.

An initial 3D digital model may contain 3D geometry information only, or it may contain both 3D geometry information and color information, and the present disclosure is not intended to be limited in this respect.

In some embodiments, a head can be measured or scanned three-dimensionally, and the data obtained from the scanning can be sent to a computer and used to build up the initial 3D digital model of the head. For example, a stylus can be used to trace the shape of a head along several lines, and an initial 3D model can be built up based on the data resulted from the tracing and by interpolating. As another example, a binocular camera can be used to capture images of a head from different angles, and these images can then be processed to obtain both 3D geometry information and color information of the head, based on which an initial 3D model can be generated. Preferably, a cap can be put on the head before scanning the head by optical means, which wraps tightly on the head, presses hair, if any, down onto head shell, and thus presents a contour that conforms to the shape of the head shell. Any other means for presenting a contour that conforms to the shape of a head shell can be used, and the methods of the present disclosure are not intended to be limited in this respect.

In some other embodiments, an initial 3D digital model of a head, or data that can be transformed into such a 3D model, may already exist, and can be obtained without conducting 3D measurement/scan of a head. The method of the present disclosure are not intended to be limited to any specific way of obtaining an initial 3D model of a head.

In step S202, information required for creating a hairpiece is obtained.

As discussed above, information required for creating a hairpiece includes, but not limited to: orientation information specifying orientation of a 3D model/mold with respect to a head; position information specifying position of a target area on the 3D model/mold; hairpiece information specifying requirement for the hairpiece, such as hair color, hair length; and section information specifying hair sections.

Then, in step S203, an indication is generated on a surface of the 3D model, which represents the information required for creating a hairpiece and forms as a part of the 3D model.

As discussed above, the indication can be a structural feature (for example, a raised structure or an indentation), a color feature, or combination of a structural feature and a color feature.

The information can be obtained by different means in step S202, and the indication can be generated by different means in step S203 as well. The methods of the present disclosure are not intended to be limited in these respects, and exemplary illustration thereof will be given hereinafter with reference to FIG. 3 to FIG. 12.

FIG. 3 and FIG. 4 show an example of a 3D model 1 with orientation indicator thereon. Such a 3D model for example can be initially obtained by three-dimensionally and optically scanning a subject's head with a white cap wrapping on the head. Computer software is commercially available for generating a 3D model using the data obtained during 3D scan. As shown in the figures, an outline of a target area, that is to be covered by a hairpiece, is marked on the white cap with a line. However, it should be noted that the methods of the present disclosure are not intended to be limited in the respect of how the initial 3D model is obtained or in the respect of whether the initial 3D model contains color information.

Orientation information is important information needed for correct manufacture of hairpiece. Orientation of a model/mold, for example, the front and back of a model/mold, can be rendered unclear after the model/mold of head is processed, because the model/mold is usually processed to remove clearly identifiable features such as eyes and nose. This makes it difficult or impossible to identify the orientation of a model/mold.

According to some embodiments, orientation of the 3D model is represented with an orientation indicator 10 (10a, 10b) formed in the 3D model.

In some embodiments, the orientation indicator comprises a symbol placed in a location, the symbol in combination with the location representing the orientation information.

In some embodiments, for obtaining orientation information, the following process can be carried out: displaying the 3D model to user; detecting a location that the user selects on the 3D model; and obtaining an input from the user about orientation of the 3D model with respect to the head. Obtaining an input from the user can comprise: presenting a dialog box asking which direction user intends to indicate at the selected location; and receiving the input from user when user operates in the dialog box. In such embodiments, generating an indication can comprise: generating a symbol at the selected location.

As an example, after scanning the head and generating the initial 3D model with 3D geometry and associated texture image (color information), the 3D model is displayed to user with a view of the 3D geometry rendered with the color information applied to the surface. The user can rotate the 3D model to see it from different angles. The user rotates and observes the 3D model to identify the front of the head/model, for example by identifying eyes and/or nose (before these features are removed). Then the user can click/touch (if using a touch screen) to select a location on the 3D model. A dialog box can be presented to ask the user if he/she intends to indicate the front or the back of the model. If the user chooses “Front”, then as shown in FIG. 3, a symbol 10a, for example a 3D “F” character, is generated at the location that the user has selected. The same operation can be repeated to indicate the back of the 3D model with a symbol 10b, for example a 3D “B” character (shown in FIG. 4). Characters “F” and “B” are only exemplary; the symbol used for orientation indicator can be any other character or other kinds of symbol, for example characters “L” for left and “R” for right, or arrows.

In some other embodiments, for obtaining orientation information, the orientation of the 3D model with respect to the head can be identified automatically with an algorithm based on the 3D model. In such embodiments, orientation indicator can be generated automatically according to the result of the identification of the orientation, and can also comprise a symbol placed at a selected location for representing the orientation together with the location.

By generating an orientation indicator on a 3D model before identifiable features are removed from the model, the orientation of the 3D model can be identified and the orientation information can be indicated and presented correctly on the final 3D model and the physical mold.

Position information which specifies the position of a target area to be covered by a hairpiece on the 3D model/mold is also very important for correct manufacture of hairpiece. Here, “position of a target area” means the range of the target area. Without position information, the target area cannot be defined, and thus an outline of the hairpiece to be custom made cannot be correctly determined.

In some embodiments, a target area indicator is generated in the 3D model, which represents the position of the target area.

In some embodiments, position information can be obtained by identifying the target area, for example, by receiving an input from the user that traces an outline of the target area on the 3D model.

In the example shown in FIG. 3 and FIG. 4, a mark/line has been made on the white cap, which is wrapping on the head, for indicating the outline 1b of the target area 1a, and this mark/line can be seen from the 3D model. For identifying the target area, the 3D model can be displayed to user with a view of the 3D geometry rendered with the color information (only grey scale information in FIG. 3 and FIG. 4) applied to the surface. The user can move or rotate the 3D model while tracing the line on the 3D model. The tracing of the line can be detected/received as an input from the user for indicating the outline 1b of the target area 1a. However, it will be understood by those skilled in the art that the methods of the present disclosure are not limited to any specific way for identifying the outline of the target area.

In some other embodiments, position information can be obtained by identifying the target area automatically with an algorithm based on the 3D model.

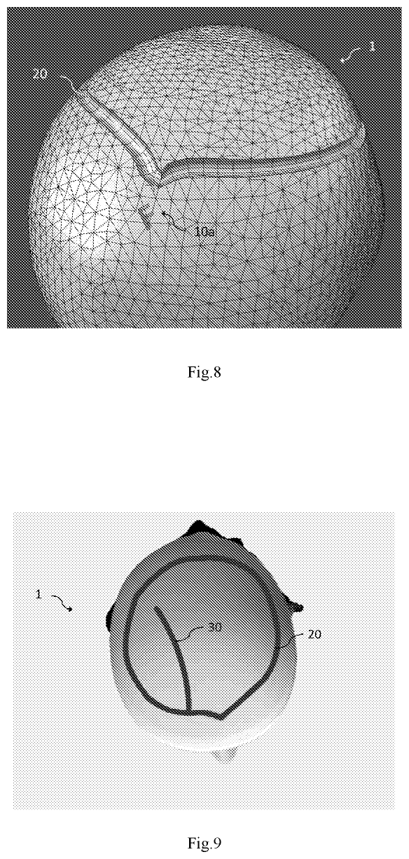

In some embodiments, the target area indicator comprises a curve along an outline of the target area. Examples of target area indicator comprising such a curve can be found in FIG. 7, FIG. 8 and FIG. 9. In some other embodiments, the target area indicator comprises a color feature in the target area that is different from the color in at least ambient area on the 3D model.

In the methods of the present disclosure, it is preferred for a symbol of an orientation indicator to be placed at a location which is within a predetermine distance from the outline of the target area on the 3D model. Because the 3D model/mold will optimally be cut to remove geometry that is not needed for creating a hairpiece.

Examples of the process for generating an indication as a structural feature on a surface of 3D model will be given below with reference to FIG. 5 to FIG. 8.

When an indication/indicator comprises a curve, which is intended to be presented as a structural feature, the following process can be carried out for generating the indication/indicator: generating a solid 3D geometry by extruding along the curve a section figure (e.g. a circle), which defines the cross-section of the solid 3D geometry and is centered on the curve; and combining/subtracting the solid 3D geometry onto/from the geometry of the 3D model.

FIG. 5 schematically illustrating the process for extruding a section FIG. 2a along a curve 2b. In the example of FIG. 5, the section FIG. 2a is a circle; however, other suitable figure can be used as a section figure, such as a rectangle.

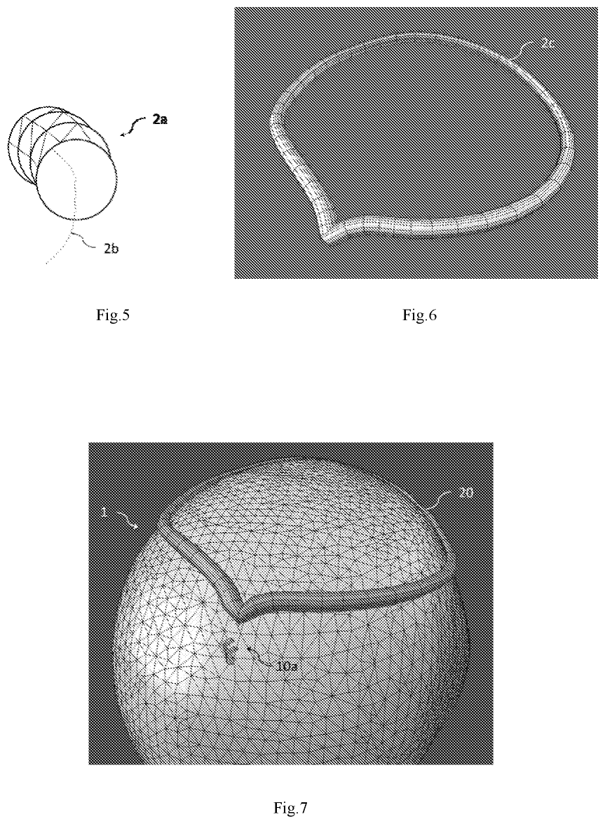

FIG. 6 shows an example of a solid 3D geometry 2c generated along an outline of a target area with the process of FIG. 5.

FIG. 7 shows a target area indicator 20 obtained by combining the solid 3D geometry 2c of FIG. 6 onto the 3D model. The resulting target area indicator 20 is in the form of raised structure on the surface of the 3D model 1.

FIG. 8 shows a target area indicator 20 obtained by subtracting the solid 3D geometry 2c of FIG. 6 from the 3D model 1, such that the solid 3D geometry is carved out of the geometry of the 3D model 1. As a result, the target area indicator 20 is in the form of indentation in the surface of the 3D model.

The advantage of carving the indication/indicator into the 3D model/physical mold is that less expensive and more common manufacturing practices can be used, which do not require complicated coloring technology. The indication can additionally be digitally modified before production to adjust the size of indication to be consistent with bit sizes, so that the number of bit changes on the machine can be minimized and the number of passes needed and such the time to carve/mill can be reduced.

In FIG. 7 and FIG. 8, character “F” as an orientation indicator in the form of a structural feature is also shown in an exemplary way. For such a character symbol or other kind of symbol, a template 3D geometry can be generated (for example, by extruding a planar symbol), and an indicator in the form of raised structure or indentation can be generated on the 3D model by combining/subtracting the template 3D geometry onto/from the 3D model.

Position information can further specify position of hair part line on the 3D model/mold, and accordingly, the position indication can further comprise a part line indicator that represents the position of the hair part line.

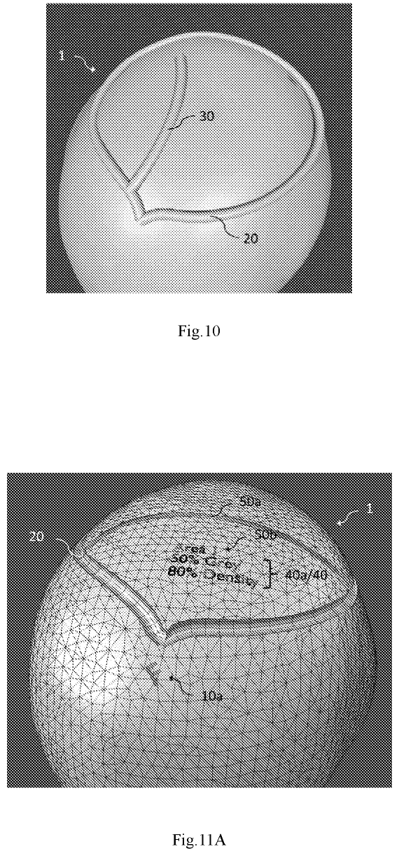

FIG. 9 schematically shows an example of a 3D model 1 with both target area indicator 20 and part line indicator 30, which are in the form of color feature. FIG. 10 schematically shows another example of a 3D model 1 with target area indicator 20 and part line indicator 30, which are in the form of a raised structural line.

According to some embodiments, hairpiece information, which specifies requirement for hairpiece, and section information, which specifies hair sections, can also be represented with indications on the 3D model.

The hairpiece information may specify requirements for the hairpiece such as hair color, hair length, hair density, hair direction, grey percentage and hair wave. A hairpiece indicator can be generated to represent the hairpiece information according to embodiment of the present disclosure.

In some embodiments, hairpiece information is obtained by obtaining an input from the user that specifies the requirement for the hairpiece. For example, hairpiece information is obtained by presenting a dialog box with options for the requirement for the hairpiece; and receiving an input from the user when the user selects in the dialog box.

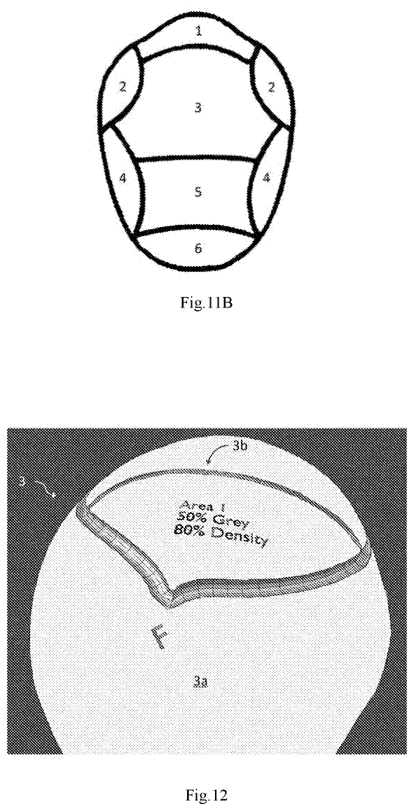

FIG. 11A shows an example of a 3D model 1 with hairpiece indicator 40. As shown in FIG. 11A, the hairpiece indicator 40 can comprise character symbol 40a.

The hairpiece indicator 40 is preferably in the form of indentation or a color feature or a combination of the two.

Also, a section indicator 50 can be generated on the 3D model 1 to represent section information according to some embodiments. FIG. 11B schematically shows exemplary hair sections.

The Example of 3D model shown in FIG. 11A contains also a section indicator. As shown in FIG. 11A, a section indicator 50 can comprise curves 50a indicating boundaries of the hair sections. The curves 50a are preferably in the form of indentation, color feature or combination thereof. The section indicator 50 can further comprise symbols 50b in respective hair sections. The section indicator 50 shown in FIG. 11A is in the form of indentation. Preferably, a hairpiece indicator 40 for a specific section of the hair sections is positioned within that section, as shown in FIG. 11A.

In some embodiments, the section information can be obtained by: identifying a hair region that is supposed to be covered by natural growing hair and hairpiece; and applying a predetermined mask that indicates hair sections, onto the hair region. As an example, the hair region can be identified by receiving an input from the user that traces a boundary of the hair region on the 3D model. As another example, the hair region can be identified automatically with an algorithm based on the initial 3D model. The predetermined mask can contain a layout of hair sections as shown in FIG. 11B or any other suitable layout of hair sections.

In another aspect, the present disclosure also provides a physical mold used for creating a hairpiece. This physical mold can be obtained through the methods of the present disclosure or any other method.

FIG. 12 shows an example of a physical mold used for creating a hairpiece of the present disclosure. As shown in FIG. 12, the physical mold 3 comprises a body 3a having a work surface 3b that is corresponding to a surface of a head, wherein the work surface 3b of the body 3a is formed with an indication, which represents information required for creating the hairpiece.

In some embodiments, the indication is a structural feature, and preferably in the form of indentation. In some other embodiments, the indication is a color feature.

The information required for creating the hairpiece can comprise orientation information specifying orientation of the physical mold with respect to the head, and accordingly, the indication can comprise an orientation indicator that represents the orientation of the 3D model.

In some embodiments, the orientation indicator comprises a symbol placed in a location, the symbol in combination with the location representing the orientation information.

The information required for creating the hairpiece can comprise position information specifying position of a target area on the physical mold, wherein the target area is an area to be covered by the hairpiece, and accordingly, the indication can comprise a target area indicator that represents the position of the target area.

In some embodiments, the position information also specifies position of hair part line on the 3D model, and the indication also comprises a part line indicator that represents the position of the hair part line.

The information required for creating the hairpiece can comprise hairpiece information specifying requirement for the hairpiece, and accordingly, the indication can comprise a hairpiece indicator that represents the requirement for the hairpiece.

For example, the requirement for the hairpiece may comprise at least one from the group consisted of hair color, hair length, hair density, hair direction, and hair wave.

The information required for creating the hairpiece can comprise section information specifying hair sections, and accordingly, the indication can comprise a section indicator that represents the hair sections.

In another aspect of the present disclosure, one or more processor readable storage devices are provided, which have encoded thereon instructions for causing one or more processors to perform the method for generating a 3D digital model with an indication used for creating a hairpiece as described above, alone or in any combination.

In yet another aspect of the present disclosure, a system for generating a 3D digital model with an indication used for creating a hairpiece is provided, which comprises: one or more processors and one or more processor readable storage devices, wherein the one or more processor readable storage devices have encoded thereon instructions for causing the one or more processors to perform the method for generating a 3D digital model with an indication used for creating a hairpiece as described above, alone or in any combination.

It should be noted that although the operation of the method is described in a particular order in the drawings, this does not require or imply that the operations must be performed in that particular order, or that all of the operations shown must be performed in order to achieve the desired result. In contrast, the steps depicted in the flowchart can change their execution order. Additionally or alternatively, certain steps can be omitted, a plurality of steps can be combined into one step, and/or a step can be decomposed into a plurality of steps.

The foregoing description is only an advantageous embodiment of the present application and a description of the technical principles of the application. It should be understood by those skilled in the art that the scope of the invention recited in this application is not limited to the technical solutions formed by the specific combination of the above-described technical features, and should also encompass other technical solutions formed by any combination of the above technical features or their equipollent features. For example, the technical solutions can be those formed through the mutual substitution between the above-mentioned features and the technical features disclosed in the present application (but not limited thereto) having similar functions.

1. A method for generating a 3D digital model with an indication used for creating a hairpiece, comprising:
obtaining an initial 3D model of a head;
obtaining information required for creating the hairpiece; and
generating an indication on a surface of the 3D model, which represents the information and forms as a part of the 3D model.

2. The method of claim 1, wherein the indication is a structural feature.

3. The method of claim 2, wherein the structural feature is in the form of indentation.

4. The method of claim 1, wherein the indication is a color feature.

5. The method of claim 1, wherein the 3D model has a work surface, which is corresponding to a surface of the head, and the indication is formed in the work surface of the 3D model.

6. The method of claim 1, wherein the information required for creating the hairpiece comprises orientation information specifying orientation of the 3D model with respect to the head, and the indication comprises an orientation indicator that represents the orientation of the 3D model.

7. The method of claim 6, wherein the orientation indicator comprises a symbol placed in a location, the symbol in combination with the location representing the orientation information.

8. The method of claim 7, wherein the location is within a predetermined distance from an outline of a target area on the 3D model, wherein the target area is an area to be covered by the hairpiece.

9. The method of claim 8, wherein said obtaining information required for creating the hairpiece comprises:
displaying the 3D model to user;
detecting a location that the user selects on the 3D model; and
obtaining an input from the user about orientation of the 3D model, and
wherein, said generating an indication comprises generating a symbol that is corresponding to the input at the selected location.

10. The method of claim 9, wherein obtaining an input from the user comprises:
presenting a dialog box asking which direction the user intends to indicate at the selected location; and
receiving the input from the user when the user operates in the dialog box.

11. The method of claim 7, wherein said obtaining information required for creating the hairpiece comprises: identifying the orientation of the 3D model automatically with an algorithm.

12. The method of claim 7, wherein the symbol comprised in the orientation indicator comprises arrow or character.

13. The method of claim 1, wherein the information required for creating the hairpiece comprises position information specifying a position of a target area on the 3D model, wherein the target area is an area to be covered by the hairpiece, and the indication comprises a target area indicator that represents the position of the target area.

14. The method of claim 13, wherein the position information further specifies a position of a hair part line on the 3D model, and the indication further comprises a part line indicator that represents the position of the hair part line.

15. The method of claim 13, wherein said obtaining information required for creating the hairpiece comprises: identifying the target area by receiving an input from the user that traces an outline of the target area on the 3D model.

16. The method of claim 13, wherein said obtaining information required for creating the hairpiece comprises: identifying the target area on the 3D model automatically with an algorithm.

17. The method of claim 13, wherein the target area indicator comprises a curve along an outline of the target area.

18. The method of claim 17, wherein the curve is in the form of a structural feature.

19. The method of claim 13, wherein the target area indicator comprises a color feature in the target area that is different from the color at least in an ambient area that is surrounding the target area on the 3D model.

20. The method of claim 1, wherein the information required for creating the hairpiece comprises hairpiece information specifying requirement for the hairpiece, and the indication comprises a hairpiece indicator that represents the requirement for the hairpiece.

21. The method of claim 20, wherein the requirement for the hairpiece comprises at least one from the group consisted of hair color, hair length, hair density, hair direction, and hair wave.

22. The method of claim 21, wherein said obtaining information required for creating the hairpiece comprises: obtaining an input from the user specifying the requirement for the hairpiece.

23. The method of claim 22, wherein said obtaining an input from the user specifying the requirement for hairpiece comprises:
presenting a dialog box with options for the requirement for the hairpiece; and
receiving the input from the user when the user selects in the dialog box.

24. The method of claim 20, wherein the hairpiece indicator comprises character symbol.

25. The method of claim 24, wherein the hairpiece indicator is in the form of a structural feature or a color feature.

26. The method of claim 1, wherein the information required for creating the hairpiece comprises section information specifying hair sections, and the indication comprises a section indicator that represents the hair sections.

27. The method of claim 26, wherein the section indicator comprises curves indicating boundaries of the hair sections.

28. The method of claim 27, wherein the curves are in the form of a structural feature.

29. The method of claim 27, wherein the section indicator further comprises symbols in respective hair sections.

30. The method of claim 26, wherein the section indicator comprises color feature in at least one of the hair sections.

31. The method of claim 26, wherein said obtaining information required for creating the hairpiece comprises:
identifying a hair region that is supposed to be covered by natural growing hair and hairpiece; and
applying a predetermined mask that indicates hair sections, onto the hair region.

32. The method of claim 31, wherein said identifying a hair region comprises: receiving an input from the user that traces a boundary of the hair region on the 3D model.

33. The method of claim 31, wherein said identifying a hair region comprises: identifying the hair region automatically with an algorithm based on the initial 3D model.

34. A method for generating a physical mold used for creating a hairpiece, comprising:
obtaining a 3D digital model with an indication used for creating a hairpiece by using the method of claim 1; and
generating a physical mold based on the 3D model.

35. The method of claim 34, wherein said generating the physical mold is carried out by using a 3D printer or a computer-controlled carving machine.

36. The method of claim 35, wherein the indication is in the form of indentation and has a width of the same size as a bit used in the computer-controlled carving machine.

37. A physical mold used for creating a hairpiece, comprising a body having a work surface corresponding to a surface of a head, wherein the work surface of the body is formed with an indication, which represents information required for creating the hairpiece.

38. The physical mold of claim 37, wherein the indication is a structural feature.

39. The physical mold of claim 38, wherein the structural feature is in the form of indentation.

40. The physical mold of claim 37, wherein the indication is a color feature.

41. The physical mold of claim 37, wherein the information required for creating the hairpiece comprises orientation information specifying orientation of the 3D model with respect to the head, and the indication comprises an orientation indicator that represents the orientation of the 3D model.

42. The physical mold of claim 41, wherein the orientation indicator comprises a symbol placed in a location, the symbol in combination with the location representing the orientation information.

43. The physical mold of claim 42, wherein the location is within a predetermine distance from an outline of a target area on the 3D model, wherein the target area is an area to be covered by the hairpiece.

44. The physical mold of claim 42, wherein the symbol comprised in the orientation indicator comprises arrow and/or character.

45. The physical mold of claim 37, wherein the information required for creating the hairpiece comprises position information specifying position of a target area on the 3D model, wherein the target area is an area to be covered by the hairpiece, and the indication comprises a target area indicator that represents the position of the target area.

46. The physical mold of claim 45, wherein the position information further specifies position of hair part line on the 3D model, and the indication further comprises a part line indicator that represents the position of the hair part line.

47. The physical mold of claim 45, wherein the target area indicator comprises a curve along an outline of the target area.

48. The physical mold of claim 47, wherein the curve is in the form of a structural feature.

49. The physical mold of claim 45, wherein the target area indicator comprises a color feature in the target area that is different from the color at least in an ambient area which is surrounding the target area on the 3D model.

50. The physical mold of claim 37, wherein the information required for creating the hairpiece comprises hairpiece information specifying requirement for the hairpiece, and the indication comprises a hairpiece indicator that represents the requirement for the hairpiece.

51. The physical mold of claim 50, wherein the requirement for the hairpiece comprises at least one from the group consisted of hair color, hair length, hair density, hair direction, and hair wave.

52. The physical mold of claim 50, wherein the hairpiece indicator comprises character symbol.

53. The physical mold of claim 52, wherein the hairpiece indicator is in the form of a structural feature or a color feature.

54. The physical mold of claim 37, wherein the information required for creating the hairpiece comprises section information specifying hair sections, and the indication comprises a section indicator that represents the hair sections.

55. The physical mold of claim 54, wherein the section indicator comprises curves indicating boundaries of the hair sections.

56. The physical mold of claim 55, wherein the curves are in the form of a structural feature.

57. The physical mold of claim 55, wherein the section indicator further comprises symbols in respective hair sections.

58. The physical mold of claim 57, wherein the section indicator comprises color feature in at least one of the hair sections.

59. One or more processor readable storage devices having encoded thereon instructions for causing one or more processors to perform the method for generating a 3D digital model with an indication used for creating a hairpiece of claim 1.

60. A system for generating a 3D digital model with an indication used for creating a hairpiece, the system comprising: one or more processors and one or more processor readable storage devices, wherein the one or more processor readable storage devices have encoded thereon instructions for causing the one or more processors to perform the method for generating a 3D digital model with an indication used for creating a hairpiece of claim 1.
